(19) United States
(12) Patent Application Publication
(10) Pub. No.: US 2008/0107015 A1
(43) Pub. Date: May 8, 2008

(54) Apparatus for and method of preventing device address from conflicting in WiMedia MAC

(75) Inventors: Jun Haeng Cho, Yongin-si (KR); Jun Seo Lee, Yongin-si (KR); Chang Woo Seo, Yongin-si (KR); Yong Suk Kim, Yongin-si (KR); Seung Hwan Oh, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/723,858

(22) Filed: Mar. 22, 2007

(30) Foreign Application Priority Data
Nov. 2, 2006 (KR) 10-2006-0107660

(51) Int. Cl. H04L 12/56; H04J 1/16

(52) U.S. Cl. 370/216; 370/389

(57) ABSTRACT

An apparatus for preventing a device address from conflicting in a WiMedia media access control (MAC), the apparatus including: a device address conflict determination unit which determines whether a conflict between a device address of the apparatus and alien device addresses included in a received alien beacon occurs; a device address generation unit which regenerates the device address of the apparatus when the conflict occurs and a beacon group of the apparatus is not a reference beacon group; a device address information generation unit which generates information about the regenerated device address of the apparatus; and a device information update unit which updates device information of the beacon group of the apparatus, when a beacon including information about a regenerated device address of the apparatus is received from another device included in the beacon group of the apparatus.

### CROSS-REFERENCE TO RELATED APPLICATION

This application claims priority from Korean Patent Application No. 10-2006-0107660, filed on Nov. 2, 2006, in the Korean Intellectual Property Office, the entire disclosure of which is incorporated herein by reference.

### BACKGROUND OF THE INVENTION

1. Field of the Invention

Apparatuses and methods consistent with the present invention relate to a device address conflict prevention in a WiMedia media access control (MAC), and more particularly, to preventing a device address from conflicting in a WiMedia MAC due to a merging of beacon groups.

2. Description of Related Art

Generally, a device address, which is set in a device in a beacon group, is generated by the device comprising the beacon group. In this case, WiMedia devices comprise the beacon group.

Specifically, the device address is generated by the device itself without a coordinator which controls the device comprising the beacon group. In this case, the device address, which is generated by the device, is not used by the other devices comprising the beacon group.

Device addresses may be randomly generated in each device.

A device comprising a beacon group generates a device address without a coordinator on its own, which causes a conflict among device addresses. When a device receives a frame which has a device address of the device, or receives a beacon frame possessing a beacon slot which is not used in the device, in the device having the same device address, the conflict of device addresses is recognized.

Therefore, an apparatus for and a method of preventing a device address from conflicting in a WiMedia MAC due to a merging of beacon groups is required.

### SUMMARY OF THE INVENTION

The present invention provides an apparatus for and a method of preventing a device address from conflicting in a WiMedia media access control (MAC) which may recognize and prevent an address conflict between two devices when two beacon groups, which include devices having a same device address, are merged.

The present invention also provides an apparatus for and a method of preventing a device address from conflicting in a WiMedia MAC by preventing an address conflict between two devices which are included in different beacon groups respectively, when two beacon groups are merged, and thereby may provide continuous communication.

The present invention also provides an apparatus for and a method of preventing a device address from conflicting in a WiMedia MAC which may regenerate any one device address of two devices, which have a same device address, when two beacon groups including the two devices having the same device address, are merged.

The present invention also provides an apparatus for and a method of preventing a device address from conflicting in a WiMedia MAC which regenerates a device address, based on device addresses of an alien beacon group and a device address of a beacon group of a corresponding device, and thereby may prevent the device address from conflicting again.

According to an aspect of the present invention, there is provided an apparatus for preventing a device address from conflicting in a WiMedia MAC, the apparatus including: a device address conflict determination unit which determines whether a conflict between a device address of the apparatus and alien device addresses included in a received alien beacon occurs; a device address generation unit which regenerates the device address of the apparatus when the conflict occurs and a beacon group of the apparatus is not a reference beacon group; a device address information generation unit which generates information about the regenerated device address of the apparatus; and a device information update unit which updates device information of the beacon group of the apparatus, when a beacon including information about a regenerated device address of the apparatus is received from another device included in the beacon group of the apparatus.

When the conflict occurs and the beacon group of the apparatus is the reference beacon group, the device address of the apparatus may be prevented from being regenerated.

When any one device address of the alien device addresses, included in a MAC address and fields of an alien beacon frame, is identical to the device address of the apparatus, it is determined that the conflict occurs.

When the conflict occurs and the corresponding beacon group is not the reference beacon group, the device address of the apparatus, excluding the alien device addresses and device addresses included in the beacon group of the apparatus may be regenerated.

The generated information about the regenerated device address of the apparatus includes the device address of the apparatus in which the conflict occurs, the regenerated device address of the apparatus, and a point in time to begin using the regenerated device address of the apparatus.

The apparatus for preventing a device address from conflicting in a WiMedia MAC may further include a beacon generation unit which generates a beacon including information about the regenerated device address of the apparatus.

According to another aspect of the present invention, there is provided a method of preventing a device address from conflicting in a WiMedia MAC, the method including: determining whether a conflict between a device address of an apparatus for preventing the device address from conflicting in the WiMedia MAC and alien device addresses included in a received alien beacon occurs; determining whether a beacon group of the apparatus is a reference beacon group when the conflict occurs; regenerating the device address of the apparatus in which the conflict occurs, when the beacon group of the apparatus is not the reference beacon group; generating information about the regenerated device address of the apparatus; and updating device information of the beacon group of the apparatus, when a beacon including information about a regenerated device address of the apparatus is received from another device included in the beacon group of the apparatus.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating an apparatus for preventing a device address from conflicting in a WiMedia media access control (MAC) according to an exemplary embodiment of the present invention;

FIG. 2 is a diagram illustrating an example of two beacon groups according to an exemplary embodiment of the present invention;

FIG. 3 is a diagram illustrating an example of information about a device address which is regenerated by a device address information generation unit illustrated in FIG. 1;

FIG. 4 is a diagram illustrating an example of a reservation period before and after merging two beacon groups according to an exemplary embodiment of the present invention;

FIG. 5 is a flowchart illustrating a method of preventing a device address from conflicting in a WiMedia MAC according to an exemplary embodiment of the present invention; and

FIG. 6 is a flowchart illustrating an operation of updating device information via a beacon received from another device according to an exemplary embodiment of the present invention.

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

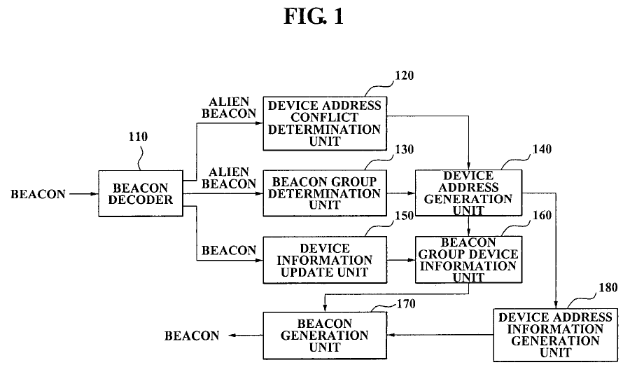

FIG. 1 is a block diagram illustrating an apparatus for preventing a device address from conflicting in a WiMedia media access control (MAC) according to an exemplary embodiment of the present invention.

Referring to FIG. 1, the apparatus for preventing a device address from conflicting in a WiMedia MAC includes a beacon decoder, 110, a device address conflict determination unit 120, a beacon group determination unit 130, a device address generation unit 140, a device information update unit 150, a beacon group device information unit 160, a beacon generation unit 170, and a device address information generation unit 180.

The beacon decoder 110 decodes a beacon received at a corresponding device.

In this case, when the received beacon is an alien beacon received from an alien beacon group, the beacon decoder 110 outputs the decoded beacon to the device address conflict determination unit 120 and the beacon group determination unit 130. When the received beacon is received from a beacon group including the corresponding device, the beacon decoder 110 outputs the decoded beacon to the device information update unit 150.

The device address conflict determination unit 120 determines whether a conflict between a device address of the corresponding device and alien device addresses occurs. The alien device addresses are included in the alien beacon. Specifically, when a device address, which is identical to the device address of the corresponding device, is included in the alien device addresses, the device address conflict determination unit 120 determines that the conflict occurs.

The device address conflict determination unit 120 outputs whether the conflict occurs and the alien device addresses, to the device address generation unit 140.

When any one device address of the alien device addresses, included in a MAC address and fields of an alien beacon frame, is identical to the device address of the corresponding device, the device address conflict determination unit 120 may determine that the conflict occurs.

The beacon group determination unit 130 determines whether the beacon group of the corresponding device is a reference beacon group, which is previously determined, based on information included in the alien beacon. Also, the beacon group determination unit 130 outputs a result of the determination. As an example, when the beacon group of the corresponding device is the reference beacon group, the beacon group determination unit 130 outputs ‘0’, and when the beacon group of the corresponding device is not the reference beacon group, the beacon group determination unit 130 outputs ‘1’.

The device address generation unit 140 regenerates the device address of the corresponding device, when the conflict occurs and the beacon group of the corresponding device is not the reference beacon group. Specifically, when the device address of the corresponding device is identical to any one of the alien device addresses as a result of the determination by the device address conflict determination unit 120, and when the beacon group of the corresponding device is not the reference beacon group as the result of the determination by the beacon group determination unit 130, the device address generation unit 140 regenerates the device address of the corresponding device.

The device address generation unit 140 may not regenerate the device address of the corresponding device, when the conflict occurs and the beacon group of the corresponding device is the reference beacon group. Specifically, when two beacon groups are merged and the beacon group of the corresponding device is the reference beacon group, the device address of the corresponding device is maintained, although the conflict occurs.

The device address generation unit 140 may regenerate the device address of the corresponding device, excluding the alien device addresses and device addresses included in the beacon group of the corresponding device.

The device address information generation unit 180 generates information about the regenerated device address of the corresponding device. The regenerated device address is regenerated by the device address generation unit 140.

The generated information about the regenerated device address of the corresponding device may include the device address of the corresponding device in which the conflict occurs, the regenerated device address of the corresponding device, a point in time to begin using the regenerated device address of the corresponding device, and a reason for a regeneration of the device address of the corresponding device.

As an example, a value of the reason for a regeneration of the device address may be ‘0’ when the device address of the corresponding device is regenerated since the conflict of device addresses occurs due to the merger of two beacon groups.

The point in time to begin using the regenerated device address of the corresponding device refers to information about when to begin using the regenerated device address of the corresponding device. The regenerated device address of the corresponding device is regenerated in other devices included in the beacon group of the corresponding device.

The beacon generation unit 170 generates a beacon including the information about the regenerated device address of the corresponding device, and transmits the information to the other devices included in the beacon group of the corresponding device.

When the beacon, received by the beacon decoder 110, is received from the other devices included in the beacon group of the corresponding device, and the received beacon includes the information about the regenerated device address of the corresponding device, the device information update unit 150 extracts and updates the information about the regenerated device address of the corresponding device.

Specifically, the device information update unit 150 updates information about the device in which the device address is regenerated, among information about devices included in the beacon group. The beacon group is stored in the beacon group device information unit 160.

Although the device address is changed via the information about the device in which the device address is regenerated, i.e., a device address which is currently used, a regenerated device address, and a point in time to begin using the regenerated device address, all devices included in the beacon group of the corresponding device recognize the regenerated device address. Accordingly, a continuous communication among devices may be performed.

The regenerated device address of the corresponding device or the regenerated device address of another device is used at the point in time to begin using the regenerated device address. As an example of a change by the regenerated device address, when a communication from the device address, which is currently used, to another device address is performed, the device address which is currently used is changed to the regenerated device address. Also, when a unicast frame is transmitted to the device address which is currently used, a destination address of a MAC header is changed to the regenerated device address.

The beacon group device information unit 160 manages information about devices included in the beacon group of the corresponding device. As an example, information about a beacon slot of each device, information about a reservation, and the like are managed.

When the device address of the corresponding device is regenerated by the device address generation unit 140, the beacon group device information unit 160 manages the currently used device address of the corresponding device and the regenerated device address of the corresponding device.

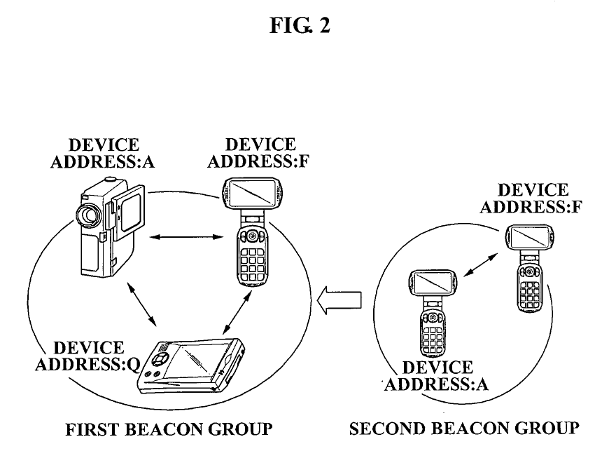

An operation illustrated with reference to FIG. 1 is described in detail with reference to FIGS. 2, 3, and 4.

FIG. 2 is a diagram illustrating an example of two beacon groups according to an exemplary embodiment of the present invention.

Referring to FIG. 2, a first beacon group includes devices having a device address A, a device address F, and a device address Q, respectively. A second beacon group includes devices having a device address A and a device address F, respectively.

When the second beacon group moves to the first beacon group and the two beacon groups receive an alien beacon, a conflict among device addresses of the devices having the device address A and the device address F occurs. Accordingly, a device address of devices, which are not included in a reference beacon group, is regenerated.

Hereinafter, it is assumed that the first beacon group is the reference beacon group.

The two devices included in the second beacon group receive a beacon which is transmitted from devices included in the first beacon group. Also, a device address conflict determination unit of a corresponding device compares device addresses included in a beacon, i.e., the device address A, the device address F, and the device address Q, with a device address of the corresponding device. Accordingly, the device address conflict determination unit 120 may determine whether the conflict occurs.

The devices included in the second beacon group regenerate the device address of the corresponding device, since the conflict occurs. In this case, it is assumed that the device having the device address A regenerates the device address as device address C, and the device having the device address F regenerates the device address as device address D.

The device which regenerates the device address as device address C generates information about the regenerated device address C, and transmits a beacon including the information about the regenerated device address C.

The device which regenerates the device address as device address D generates information about the regenerated device address D, and transmits a beacon including the information about the regenerated device address D.

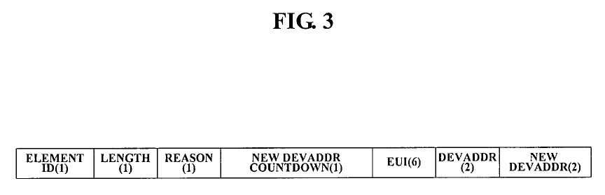

FIG. 3 is a diagram illustrating an example of information about a device address which is regenerated by a device address information generation unit illustrated in FIG. 1.

Referring to FIG. 3, information about a regenerated device address includes an element identification (ID), a length, a reason, a new DevAddr countdown, an extended unique identifier (EUI), a DevAddr, and a new DevAddr field.

The element ID is a field which indicates an identifier of information about the regenerated device address.

The length is a field which indicates an octet length of information after the length field in FIG. 3.

The reason is a field which indicates information about a reason a device address is regenerated.

As an example, a reason field value of ‘0’ may indicate a conflict of device address due to a merger of beacon groups.

The new DevAddr countdown is a filed which indicates a point in time to begin using the regenerated device address. A new DevAddr countdown field value decreases by 1 for each superframe.

The EUI is a field which indicates a MAC address value of the device.

The DevAddr is a field which indicates a device address which is currently used, and may be a device address A or a device address F.

The new DevAddr is a field which indicates the regenerated device address. When the DevAddr is the device address A, the new DevAddr is the device address C, and when the DevAddr is the device address F, the new DevAddr is the device address D.

When a beacon including the information about the regenerated device address, which has a configuration illustrated in FIG. 3, is transmitted from a device having the device address A to a device having the device address F, a device information update unit of the device having the device address F updates information about the device having the device address A, via the information about the regenerated device address included in the beacon.

Also, when the beacon including the information about the regenerated device address is transmitted from the device having the device address F to the device having the device address A, the device information update unit of the device having the device address A updates information about the device having the device address F, via the information about the regenerated device address included in the beacon.

As described above, an apparatus for preventing a device address from conflicting in a WiMedia MAC according to an exemplary embodiment of the present invention regenerates an address of a device in which a conflict occurs, among devices included in a beacon group, before merging two beacon groups. In this case, the beacon group is not a reference beacon group. Accordingly, a continuous communication among devices may be performed.

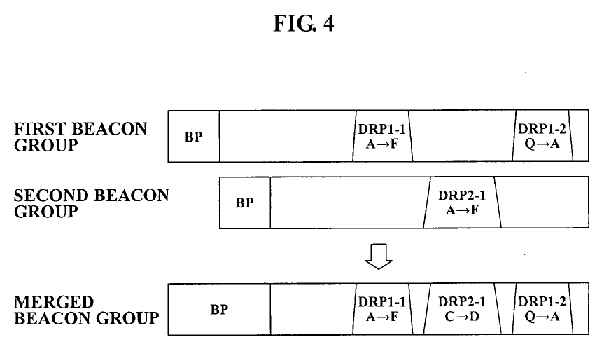

As an example, a reservation period before and after merging two beacon groups according to an exemplary embodiment of the present invention is described with reference to FIG. 4. While a communication among devices included in a first beacon group and a second beacon group is performed, devices, which are included in the second beacon group and not a reference beacon group, receive an alien beacon transmitted from devices of the first beacon group, before merging the two beacon groups. A conflict is recognized through device addresses included in the received alien beacon, and a device address is regenerated. Accordingly, a communication, which is performed in each beacon group, may be continuously performed, although the two beacon groups are merged.

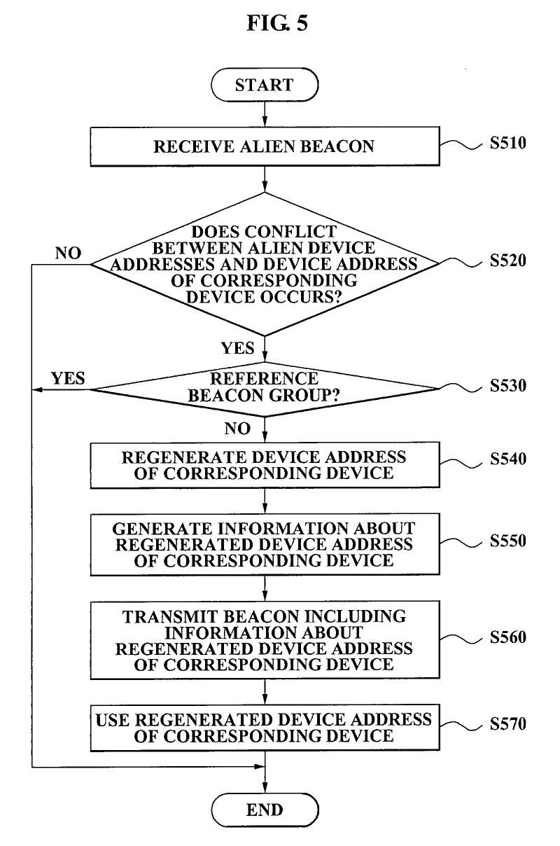

FIG. 5 is a flowchart illustrating a method of preventing a device address from conflicting in a WiMedia MAC according to an exemplary embodiment of the present invention.

Referring to FIG. 5, in operation S510, an alien beacon is received from an alien beacon group. In operation S520, it is determined whether a conflict between alien device addresses, included in the alien beacon, and a device address of a corresponding device occurs.

In this case, when any one device address of the alien device addresses included in a MAC address and fields of an alien beacon frame, is identical to the device address of the corresponding device, it is determined that the conflict occurs.

According to a result of the determination in operation S520, when the conflict occurs, it is determined whether a beacon group of the corresponding device is a reference beacon group in operation S530.

According to a result of the determination in operation S530, when the beacon group of the corresponding device is not the reference beacon group, the beacon group of the corresponding device is regenerated to prevent device addresses from conflicting, and to provide a continuous communication after merging two beacon groups in operation S540.

In this case, whether the beacon group of the corresponding device is the reference beacon group may be determined based on the alien beacon which is received from the alien beacon group.

In this case, the regenerated device address of the corresponding device may be any one of device addresses excluding the alien device addresses and device addresses included in the beacon group of the corresponding device.

When the conflict occurs and the beacon group of the corresponding device is the reference beacon group, the device address of the corresponding device is not regenerated.

In operation S550, when the device address of the corresponding device is regenerated, information about the regenerated device address of the corresponding device is generated.

The information about the regenerated device address of the corresponding device may include the device address of the corresponding device in which the conflict occurs, the regenerated device address of the corresponding device, and a point in time to begin using the regenerated device address of the corresponding device.

In operation S560, a beacon including the information about the regenerated device address of the corresponding device is generated, and the generated beacon is transmitted to other devices of the beacon group of the corresponding device.

In operation S570, the regenerated device address of the corresponding device is used after transmitting the beacon to the other devices.

The point in time to begin using the regenerated device address of the corresponding device may be determined by a value of a new DevAddr countdown field illustrated in FIG. 3.

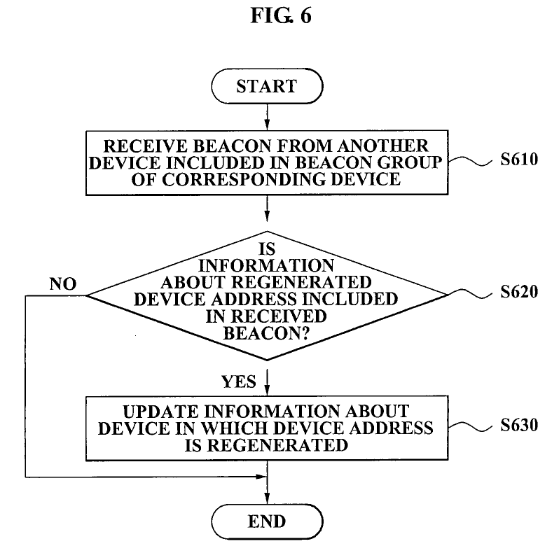

FIG. 6 is a flowchart illustrating an operation of updating device information via a beacon received from another device according to an exemplary embodiment of the present invention.

Referring to FIG. 6, in operation S610, a beacon is received from another device included in a beacon group of a corresponding device. In operation S620, it is determined whether information about a regenerated device address is included in the received beacon.

According to a result of determination in operation S620, when the information about the regenerated device address is included, information about a device in which a device address is regenerated is updated in operation S630.

In this case, the updated information about the device is not described in detail, since it is described in FIG. 1.

The above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, an apparatus for and a method of preventing a device address from conflicting in a WiMedia MAC may previously recognize and prevent an address conflict between two devices when two beacon groups, which include devices having a same device address, are merged.

Also, according to the present invention, an apparatus for and a method of preventing a device address from conflicting in a WiMedia MAC previously prevent an address conflict between two devices which are included in different beacon groups respectively, when two beacon groups are merged, and thereby may provide a continuous communication.

Also, according to the present invention, an apparatus for and a method of preventing a device address from conflicting in a WiMedia MAC may regenerate any one device address of two devices, which have a same device address, when two beacon groups including the two devices having the same device address, are merged.

Also, according to the present invention, an apparatus for and a method of preventing a device address from conflicting in a WiMedia MAC regenerate a device address, based on device addresses of an alien beacon group and a device address of a beacon group of a corresponding device, and thereby may prevent the device addresses from conflicting again.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for preventing a device address from conflicting in a WiMedia media access control (MAC), the apparatus comprising:
a device address conflict determination unit which determines whether a conflict between a device address of the apparatus and alien device addresses included in a received alien beacon, occurs;
a device address generation unit which regenerates the device address of the apparatus if the conflict occurs and a beacon group of the apparatus is not a reference beacon group;
a device address information generation unit which generates information about the regenerated device address of the apparatus; and
a device information update unit which updates device information of the beacon group of the apparatus, if a beacon including information about a regenerated device address of the apparatus is received from another device included in the beacon group of the apparatus.

2. The apparatus of claim 1, wherein the device address generation unit prevents the device address of the apparatus from being regenerated, if the conflict occurs and the beacon group of the apparatus is the reference beacon group.

3. The apparatus of claim 1, wherein the device address conflict determination unit determines that the conflict occurs if any one device address of the alien device addresses, included in a MAC address and fields of an alien beacon frame, is identical to the device address of the apparatus.

4. The apparatus of claim 1, wherein the device address conflict determination unit provides the device address generation unit with the alien device addresses.

5. The apparatus of claim 4, wherein the device address generation unit regenerates the device address of the apparatus, excluding the alien device addresses and device addresses included in the beacon group of the apparatus, if the conflict occurs and the beacon group of the apparatus is not the reference beacon group.

6. The apparatus of claim 1, wherein the generated information about the regenerated device address of the apparatus comprises the device address of the apparatus with which the conflict occurs, the regenerated device address of the apparatus, and a time to begin using the regenerated device address of the apparatus.

7. The apparatus of claim 1, further comprising:
a beacon generation unit which generates a beacon comprising information about the regenerated device address of the apparatus.

8. A method of preventing a device address from conflicting in a WiMedia MAC, the method comprising:
determining whether a conflict between a device address of an apparatus for preventing the device address from conflicting in the WiMedia MAC and alien device addresses included in a received alien beacon, occurs;
determining whether a beacon group of the apparatus is a reference beacon group if the conflict occurs;
regenerating the device address of the apparatus with which the conflict occurs, if the beacon group of the apparatus is not the reference beacon group;
generating information about the regenerated device address of the apparatus; and
updating device information of the beacon group of the apparatus, if a beacon comprising information about a regenerated device address of the apparatus is received from another device included in the beacon group of the apparatus.

9. The method of claim 8, further comprising:
preventing the device address of the apparatus from being regenerated, if the conflict occurs and the beacon group of the apparatus is the reference beacon group.

10. The method of claim 8, wherein the determining of the conflict determines that the conflict occurs, if any one device address of the alien device addresses, included in a MAC address and fields of an alien beacon frame, is identical to the device address of the apparatus.

11. The method of claim 8, wherein the regenerating of the device address of the apparatus regenerates the device address of the apparatus, excluding the alien device addresses and device addresses included in the beacon group of the apparatus, if the conflict occurs and the beacon group of the apparatus is not the reference beacon group.

12. The method of claim 8, wherein the generated information about the regenerated device address of the apparatus comprises the device address of the apparatus with which the conflict occurs, the regenerated device address of the apparatus, and a point in time to begin using the regenerated device address of the apparatus.

13. The method of claim 8, further comprising:
generating a beacon comprising information about the regenerated device address of the apparatus.

14. A computer-readable recording medium storing a program for implementing a method of preventing a device address from conflicting in a WiMedia MAC, the method comprising:
determining whether a conflict between a device address of an apparatus for preventing the device address from conflicting in the WiMedia MAC and alien device addresses included in a received alien beacon, occurs;
determining whether a beacon group of the apparatus is a reference beacon group if the conflict occurs;
regenerating the device address of the apparatus with which the conflict occurs, if the beacon group of the apparatus is the reference beacon group;
generating information about the regenerated device address of the apparatus; and
updating device information of the beacon group of the apparatus, if a beacon comprising information about the regenerated device address of the corresponding device is received from another device included in the beacon group of the corresponding device.
